(19) United States
(12) Patent Application Publication
(10) Pub. No.: US 2010/0254858 A1
(43) Pub. Date: Oct. 7, 2010

(54) MICROCHANNEL STRUCTURES HAVING BONDED LAYERS INCLUDING HEIGHT CONTROL FEATURES

(76) Inventors: Prawin Paulraj, Beaverton, OR (US); Brian K. Paul, Corvallis, OR (US)

Correspondence Address: LUMEN PATENT FIRM, 350 Cambridge Avenue, Suite 100, PALO ALTO, CA, 94306, US

(21) Appl. No.: 12/734,297

(22) PCT Filed: Nov. 13, 2008
(86) PCT No.: PCT/US2008/012834

§ 371 Date: Apr. 21, 2010

Related U.S. Application Data
(60) Provisional application No. 61/003,187, filed on Nov. 14, 2007.

(51) Int. Cl. B01L 3/00; B44C 1/22; B23K 31/02

(52) U.S. Cl. 422/100; 216/33; 228/165

(57) ABSTRACT

Patterned layers including height control features are stacked and bonded to form microchannels in a micro-fluidic device. The heights of the microchannels are determined by the height control features of the patterned layers. Side walls of the microchannels are partially formed or completely formed by the height control features. Layers are bonded together with a bonding agent disposed between the layers and outside the microchannels near the microchannel side walls. This approach provides numerous significant advantages. Material consumption can be reduced by up to 50%. Mass production can be made easier. Lateral dimensions of microchannels can be more readily controlled. Erosion of the bonding agent by flow through the microchannels can be greatly reduced.

### FIELD OF THE INVENTION

This invention relates to micro-fluidic devices, especially in connection with micro energy and chemical systems (MECS).

### BACKGROUND

MECS technology is the application of micro-fluidics to the bulk processing of mass and energy in microchannel arrays. Applications for MECS devices include microelectronic cooling, automotive heat pumps, portable power generation, fuel cells, biodiesel synthesis, point-of-use synthesis, and microchannel fuel reformers. Micro-fluidic devices for MECS applications tend to have the following characteristics. First, as microchannel arrays, they are typically relatively large meso-scale devices and are generally intended for bulk fluid processing. They tend not to include electronic components such as signal processing circuitry or sensors. Second, these MECS devices are primarily designed to provide a high surface area to volume ratio, in order to provide high rates of heat/mass transfer and/or surface reaction. Third, MECS devices are often fabricated by bonding several layers together to form channels, and it is highly desirable for fabrication methods to not require clean room facilities.

FIG. 1 shows an example of a conventional MECS fabrication approach. In this example, an exploded view of a three-layer structure including layers 102, 104, and 106 is shown. Layer 106 is a base layer that has no features. Layer 104 is a stencil layer that has a rectangular aperture 108 defined in it. Layer 102 is a top layer that includes input port 110 and output port 112. Assembly for this example entails stacking these layers on top of each other and bonding the resulting structure together. Once this is done, a micro-channel is formed having top and bottom walls defined by layers 102 and 106, respectively, and having side walls defined by aperture 108 in stencil layer 104. Fluid can enter and exit this channel by way of ports 110 and 112.

This conventional approach can be extended to provide structures having multiple vertically separated micro-channels, as in the example of FIG. 2. This figure shows a side view of an assembled structure where channels 216, 218, and 220 are separated by layers 206 and 208. Top and bottom end layers 202 and 204 define the top and bottom of the assembly. Channels 216, 218, and 220 are formed by making apertures in stencil layers 210, 212, and 214, respectively. References US 2007/0029365 and US 2003/0133358 provide further details relating to this stencil layer approach. Such stencil layers can also be referred to as spacer layers. Some other aspects of micro-fluidic device fabrication are considered in U.S. Pat. No. 6,509,085, U.S. Pat. No. 5,932,315, U.S. Pat. No. 5,443,890, U.S. Pat. No. 6,672,502, and U.S. Pat. No. 6,793,831.

However, the above described approach of fabricating MECS devices using stencil/spacer layers to define the micro-channels suffers from substantial disadvantages. First, the use of stencil layers can undesirably increase the size and cost of micro-channel arrays, because channel height is set by stencil layer thickness. Second, layer bonding in this approach is typically done by diffusion bonding or hot-press bonding. Such bonding approaches are time-consuming (e.g., several hours is typical for diffusion bonding) and scale poorly to mass production.

Accordingly, it would be an advance in the art to provide MECS devices and fabrication methods that alleviate these disadvantages of the conventional stencil layer approach.

### SUMMARY

In embodiments of the invention, patterned layers including height control features are stacked to form microchannels in a micro-fluidic device. The heights of the microchannels are determined by the height control features of the patterned layers. Side walls of the microchannels are partially formed or completely formed by the height control features. Layers are bonded together with a bonding agent disposed between the layers and outside the microchannels near the microchannel side walls. This approach provides numerous significant advantages.

First, the amount of layer material required to fabricate a give micro-fluidic device is significantly reduced, because there is no need for stencil layers when height control features are employed. This elimination of the stencil layers can reduce layer material consumption by up to 50%, and can also provide substantial cost and weight savings.

Second, the use of a bonding agent lends itself to mass production, because operations such as adhesive curing and solder reflow tend to take substantially less time than diffusion bonding.

Third, the lateral dimensions of the microchannels can be well-defined by the height control features that form the microchannel side walls. This is in contrast to the situation in the stencil layer approach, where excess bonding agent between the layers being bonded can end up in the microchannels, undesirably altering their dimensions.

Fourth, the formation of side walls with height control features serves to protect the bonding agent from erosion by flow of material within the microchannels. If the channel side wall is completely formed by the height control features (i.e., there is no gap between the height control features of one layer and the adjacent layer), then the bonding agent is completely protected from erosion because fluid flowing in the microchannel does not make contact with the bonding agent.

If the channel side wall is only partially formed by the height control features (i.e., there is a gap between the height control features of one layer and the adjacent layer), then the bonding agent can still be substantially protected from erosion. Even though fluid flowing in the microchannel makes contact with the bonding agent in this situation, the fluid flow velocity and pressure acting on the bonding agent can be greatly reduced by the presence of the side wall height control features, thereby significantly reducing erosion.

### BRIEF DESCRIPTION OF THE DRAWINGS

FIG. 1 shows an exploded view of a prior art micro-fluidic device.

FIG. 2 shows a side view of a prior art micro-fluidic device.

FIG. 3 shows an exploded view of a micro-fluidic device according to an embodiment of the invention.

FIG. 4 shows a side view of a micro-fluidic device according to an embodiment of the invention.

FIG. 5 shows an exploded view of a micro-fluidic device according to an embodiment of the invention.

FIG. 6a shows an exploded view of a micro-fluidic device according to an embodiment of the invention.

FIG. 6b shows a side view of a micro-fluidic device according to an embodiment of the invention.

FIG. 7 shows a layer suitable for use in embodiments of the invention.

FIGS. 8-10 show an example of patterned layers according to an embodiment of the invention.

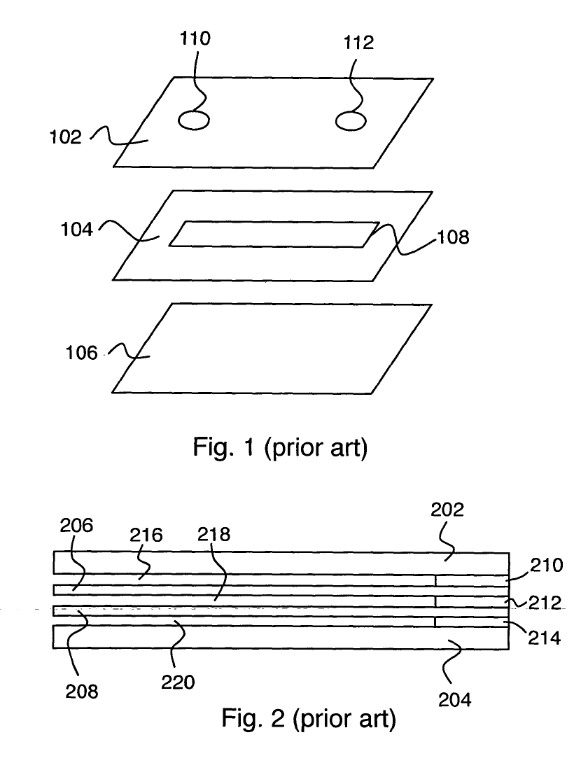

### DETAILED DESCRIPTION

FIG. 3 shows an exploded view of a micro-fluidic device according to an embodiment of the invention. In this example, a generally planar top layer 302 has an input port 304 and an output port 306. A generally planar bottom layer 308 is patterned such that it includes height control feature 310. In this example, height control feature 310 is a ridge that defines the lateral boundary of a microchannel 312. Bonding agent 314 is disposed in proximity to the channel sidewalls formed by ridge 310 and outside microchannel 312. Assembly of this structure entails stacking layer 302 on top of layer 308 (with proper lateral alignment), and then bonding the layers together (e.g., by solder reflow if bonding agent 314 is solder, by curing if bonding agent 314 is an adhesive, etc.).

In more general terms, devices according to embodiments of the invention include two or more generally planar layers, where one or more of these layers are patterned layers, and where each of the patterned layers includes one or more height control features. The layers are disposed in a stack such that one or more microchannels are formed between the layers. The microchannels have heights determined by the height control features and have side walls that are at least partially formed by the height control features. The layers are bonded together with a bonding agent disposed outside of the microchannels and in proximity to the microchannel side walls.

Methods of embodiments of the invention include the following: providing two or more generally planar layers; processing one or more of these layers to provide one or more patterned layers, each of the patterned layers including one or more height control features; disposing the layers in a stack such that one or more microchannels are formed between the layers, the microchannels having heights determined by the height control features and having side walls at least partially formed by the height control features; and bonding the layers together with a bonding agent disposed outside of the microchannels and in proximity to the microchannel side walls.

Practice of the invention does not depend critically on the bonding agent or method employed. Suitable methods include but are not limited to: adhesive bonding, soldering and brazing. Adhesives of the kind used in surface mount technology (e.g., CornerBond™ and Loctite™ Chipbonder™) have been evaluated for bonding Aluminum layers. Tests with Chipbonder™ adhesive and Al layers showed strong bonds (glue failure at 2500-3600 psi shear) that were not particularly sensitive to surface preparation (e.g., level of cleanliness). A preliminary burst test of five samples had two samples pass a test threshold of 40 psi, resulting in an estimated bond strength of 170 psi.

Other bonding agents and layer materials can also be employed in practicing embodiments of the invention. Suitable layer materials include but are not limited to: polymers; ceramics; and metals such as Aluminum, Copper, and stainless steel. Suitable bonding agents include, but are not limited to: adhesives, solders, and braze paste. Bonding agent suitability can be evaluated by an art worker by considering factors including bond strength, ease of handling, compatibility with materials being bonded, and compatibility with fluids that will be present in the microchannels during device operation.

Practice of the invention also does not depend critically on the method of forming the height control features. Suitable methods for forming these features include, but are not limited to: sheet metal stamping, sheet metal drawing, machining and etching. Various methods can be employed to place the bonding agent in its proper location(s), including but not limited to: dispensing (e.g., from a syringe), stenciling, printing and screen printing.

In cases where the bonding agent is a solder or a braze paste, it is preferred to prepare surface regions of the layers being bonded with a surface preparation compound (e.g., flux) prior to bonding. These surface regions make physical contact to the solder or braze paste, and such surface preparation is typically required to form a strong bond. After bonding is complete, any remaining residue of the surface preparation compound is preferably removed.

The use of adhesive bonding is preferred in situations where such residue removal would be difficult, because adhesive bonding advantageously eliminates the surface preparation and residue removal steps typically required for soldering. Adhesive bonding also provides the advantage of enabling the use of a wider variety of layer materials than could be used with solder bonding. For example, anodized aluminum can be bonded with adhesives, but it is difficult or impossible to solder to anodized aluminum.

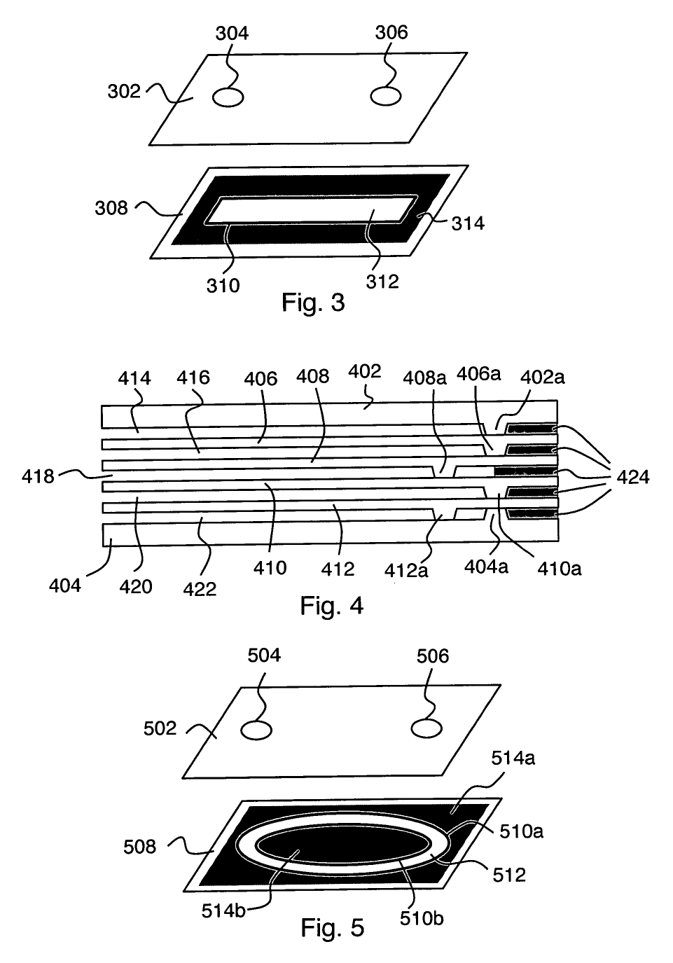

FIG. 4 shows a side view of a micro-fluidic device according to an embodiment of the invention. In this example, layers 406, 408, 410, and 412 are sandwiched between end layers 402 and 404 to define channels 414, 416, 418, 420, and 422. Height control features 402a, 404a, 406a, 408a, 410a, and 412a define the channel heights. The layers are bonded together with bonding agent 424. The height control features also serve to protect bonding agent 424 from erosion by fluid flow in the channels. Even if fluid in the channels can reach bonding agent 424 (e.g., if there is a small gap between feature 408a and layer 410), the pressure and velocity of the fluid flow acting on the bonding agent is typically greatly reduced.

The effect of height control features on fluid flow velocity at the location of the bonding agent has been modeled for various side wall gaps. In one example; a 30× reduction in both X and Y velocity components for water flow was provided by a 0.8 mil (20.3 μm) side wall gap, for inlet flow velocities on the order of 6 m/s.

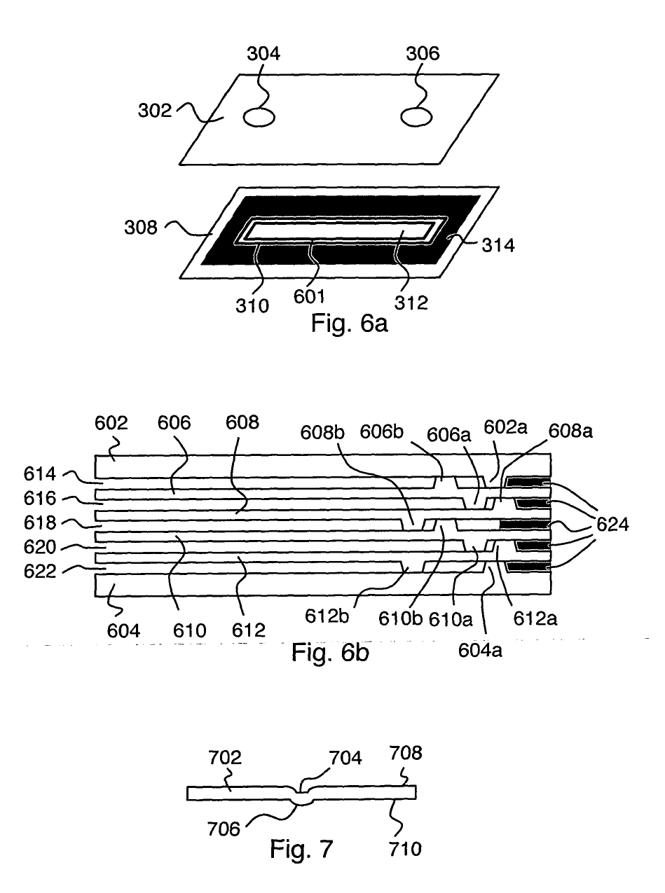

In this example, a total of six layers are used to define five vertically separated channels. In the conventional example of FIG. 2, a total of seven layers are used to define three vertically separated channels. This comparison highlights the advantageous reduction in material use provided by embodiments of the invention (e.g., as in FIGS. 4 and 6) as compared to the stencil layer approach (e.g., as in FIG. 2).

FIG. 5 shows an exploded view of a micro-fluidic device according to an embodiment of the invention. In this example, a top layer 502 includes input port 504 and output port 506. Bottom layer 508 includes height control features (i.e., ridges) 510a and 510b that define a microchannel 512. Bonding agent is disposed outside microchannel 512 as indicated by references 514a and 514b. Although bonding agent at 514b is outside microchannel 512 (i.e., not in the fluid flow path), it is surrounded by microchannel 512.

This enhanced geometrical flexibility is another advantage provided by embodiments of the invention compared to a conventional stencil layer approach. In a stencil layer approach, special measures would be required to form an annular microchannel as shown on FIG. 5, because the corresponding stencil layer would not be connected. More generally, the use of height control features to set channel height and to control bonding agent flow allows the bonding agent to be employed more readily as a structural element of a microchannel device. In the example of FIG. 5, the bonding agent at 514b helpfully serves to prevent vertical deformation under pressure.

FIG. 6a shows an exploded view of a micro-fluidic device according to an embodiment of the invention. In this example, two or more concentrically disposed ridges laterally surround a microchannel. This example is similar to the example of FIG. 3, except that a second ridge 601 is formed so that ridges 601 and 310 both concentrically surround channel 312.

FIG. 6b shows a side view of another example of a double ridge approach. In this example, layers 606, 608, 610, and 612 are sandwiched between end layers 602 and 604 to define channels 614, 616, 618, 620, and 622. Height control features 602a, 604a, 606a, 608a, 610a, 612a, 606b, 608b, 610b, and 612b define the channel heights. The layers are bonded together with bonding agent 624. The arrangement of the height control features provides double ridge protection for bonding agent 624. For example, channel 618 is separated from bonding agent 624 by ridges 608b and 610b, and the other channels also each have two corresponding ridges. This provides further protection of bonding agent 624 from erosion due to fluid flow in the channels.

As indicated above, practice of the invention does not depend critically on how height control features are formed in the patterned layers. However, experiments to date have mainly focused on the approach shown on FIG. 7. In this approach, a groove 704 is formed (e.g., by stamping) in a first surface 708 of a sheet metal layer 702. As a result, a ridge 706 is formed on a second surface 710 opposite to first surface 708.

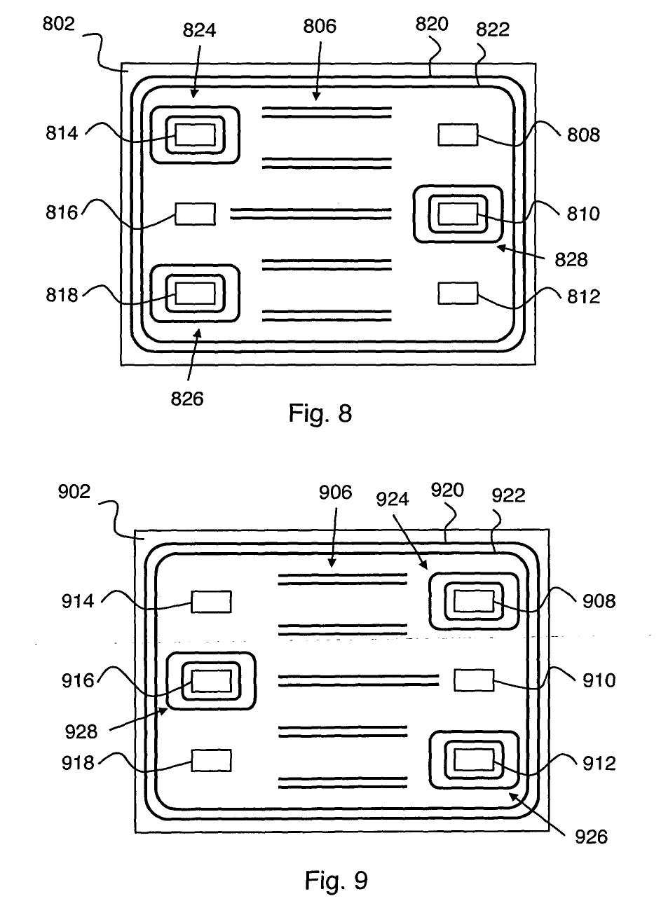

FIGS. 8 and 9 show top views of patterned layers suitable for use in an exemplary embodiment of the invention. In this example, two differently patterned layers (i.e., layer 802 of FIG. 8 and layer 902 of FIG. 9) can be vertically stacked in an alternating arrangement to provide high surface area to volume ratio (e.g., for use in a heat exchanger). Here the bottom surfaces of layers 802 and 902 (not shown) are taken to be planar, so the microchannel features are formed entirely by the features seen in the top views. Accordingly, it is preferred for the tops of all height control surfaces on layers 802 and 902 to be co-planar. In layer 802, the fluid input is at port 816 and the fluid outputs are at ports 808 and 812, or vice versa. Similarly, in layer 902, the fluid input is at port 910 and the fluid outputs are at 914 and 918, or vice versa. The height control features shown in this example (i.e., the ridges on layers 802 and 902) provide several distinct functions.

First, ridges 822 and 922 define the lateral boundary of the microchannels. Ridges 820 and 920 further define the lateral boundary of the microchannels, and provide control of the location/flow of the bonding agent. Second, ridges 806 and 906 provide vertical support within the microchannels to prevent vertical deformation or collapse of the stacked layers in response to an applied vertical force. Third, ridges 824, 826, 828, 924, 926, and 928 define sealing boxes around the layer input/output ports as shown. This arrangement of the sealing boxes forces fluid in each microchannel to flow from one end of the device to the other, which is desirable. For example, flow from port 808 to port 810 (which would be largely useless in a heat exchanger) in layer 802 is prevented by sealing box 828 around part 810.

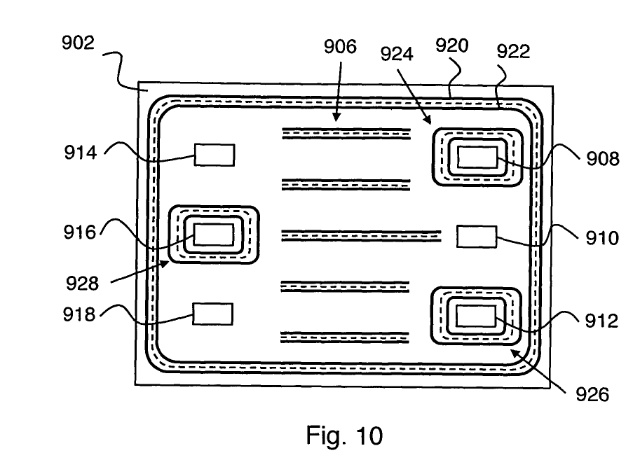

The dotted lines on FIG. 10 show where the bonding agent (e.g., an adhesive) could be disposed on layer 902 of FIG. 9. The height control features of this example are seen to provide well-defined microchannel dimensions, both vertically and laterally. Furthermore, the location of the bonding agent is also well defined by the height control features, and there is little tendency for the bonding agent to extend into the microchannels such that microchannel dimensions are significantly altered. In this example, chemical etching is a preferred method of forming the height control features, because it provides a high degree of pattern control. Patterns for etching can be defined according to any process, including but not limited to lithography, printing, etc. In this example, etching to form patterns is only done on one side of each layer. It is also possible for some or all of the layers in a MECS device to have patterns with height control features on both sides.

Practice of the invention does not depend critically on the lateral shape of the height control features. Height control features can have any lateral shape, including but not limited to: ridges, pillars, and mesas.

1. A microchannel apparatus comprising:
two or more generally planar layers, wherein one or more of said layers are patterned layers, each of said patterned layers including one or more height control features;
wherein said two or more layers are disposed in a stack such that one or more microchannels are formed between said two or more layers, said microchannels having heights determined by said height control features;
wherein side walls of said one or more microchannels are at least partially formed by said height control features;
wherein said two or more layers are bonded together with a bonding agent, and wherein said bonding agent is disposed outside of said microchannels and in proximity to said side walls of said microchannels.

2. The apparatus of claim 1, wherein said side walls comprise one or more ridges defining one or more boundaries of said one or more microchannels.

3. The apparatus of claim 2, wherein said patterned layers are sheet metal layers, and wherein grooves are formed in first surfaces of said patterned layers to form said ridges on second surfaces of said patterned layers opposite said first surfaces.

4. The apparatus of claim 2, wherein said one or more ridges are formed by chemical etching.

5. The apparatus of claim 2, wherein said ridges comprise two or more concentrically disposed ridges laterally surrounding a corresponding microchannel.

6. The apparatus of claim 2, wherein said ridges substantially protect said bonding agent from erosion due to material flow within said microchannels.

7. The apparatus of claim 1, wherein said bonding agent comprises a material selected from the group consisting of: adhesives, solders, and braze paste

8. A method of making a microchannel apparatus, the method comprising:
providing two or more generally planar layers;
processing one or more of said generally planar layers to provide one or more patterned layers, each of said patterned layers including one or mote height control features;
disposing said two or more layers in a stack such that one or more microchannels are formed between said two or more layers, said microchannels having heights determined by said height control features;
wherein side walls of said one or more microchannels are at least partially formed by said height control features;
bonding said two or more layers together with a bonding agent, wherein said bonding agent is disposed outside of said microchannels and in proximity to said side walls of said microchannels.

9. The method of claim 8, wherein said side walls comprise one or more ridges defining one or more boundaries of said one or more microchannels.

10. The method of claim 9, wherein said patterned layers are sheet metal layers, and further comprising forming grooves in first surfaces of said patterned layers to form said ridges on second surfaces of said patterned layers opposite said first surfaces.

11. The method of claim 9, wherein said ridges comprise two or more concentrically disposed ridges laterally surrounding a corresponding microchannel.

12. The method of claim 9, wherein said ridges substantially protect said bonding agent from erosion due to material flow within said microchannels.

13. The method of claim 9, wherein said ridges are formed according to a process selected from the group consisting of: sheet metal stamping, sheet metal drawing, machining, and etching.

14. The method of claim 8, wherein said bonding agent is placed into position according to a process selected from the group consisting of: dispensing, stenciling, printing, and screen printing.

15. The method of claim 8, wherein said bonding agent comprises a solder or a braze paste, and further comprising:
preparing surface regions of said layers for solder or braze paste bonding with a surface preparation compound;
removing residue of said surface preparation compound after said bonding said two or more layers together is performed.
